(19) United States
(12) Patent Application Publication
(10) Pub. No.: US 2007/0127706 A1
(43) Pub. Date: Jun. 7, 2007

(54) Ringer assemblies, methods, and related computer program products for providing customized ring tones in a public switched telephone network (PTSN)

(76) Inventors: Neale Hightower SR., Decatur, GA (US); Greg N. Patterson, Atlanta, GA (US)

Correspondence Address: MYERS BIGEL SIBLEY & SAJOVEC, P.A., P.O. BOX 37428, RALEIGH, NC, 27627, US

(21) Appl. No.: 11/291,217

(22) Filed: Dec. 1, 2005

(51) Int. Cl. H04M 1/00; H04M 3/00

(52) U.S. Cl. 379/373.02

(57) ABSTRACT

A ringer assembly for providing customized ring tones for a wireline telephone in a public switched telephone network (PSTN) is in communication with a ringer configured to provide an audible ring tone. The assembly includes a download interface configured to receive ring tone data, which includes instructions for providing an audible ring tone based on a caller identification. A PSTN interface is configured to couple with a PSTN network and to receive incoming caller identification from the PSTN network. A telephone interface is configured to couple with a wireline telephone. A controller is configured to activate the audible ring tone based on the ring tone data and the incoming caller identification.

### FIELD OF THE INVENTION

The invention relates to telephone ring tones. In particular, the invention relates to ringer assemblies, systems and methods for providing customized ring tones.

### BACKGROUND

Customized ring tones have become popular on cellular telephones. Ring tones are sounds made by the cellular telephone when an incoming call is received. In addition to traditional telephone ring sounds, ring tones can include virtually any type of sound or music, such as an excerpt from popular music (a college song, rap music, movie scores, etc.). These tones can be generated by a centralized server and downloaded to cellular telephones via an SMS or packet data system. The tones consist of a “score” in one or more formats. When an incoming call is received, the cellular telephone plays the “score” based on the incoming number using a set of pre-determined tones from a tone generator.

### SUMMARY

According to embodiments of the present invention, a ringer assembly for providing customized ring tones for a wireline telephone in a public switched telephone network (PSTN) is in communication with a ringer configured to provide an audible ring tone. The assembly includes a download interface configured to receive ring tone data, which includes instructions for providing an audible ring tone based on a caller identification. A PSTN interface is configured to couple with a PSTN network and to receive incoming caller identification from the PSTN network. A telephone interface is configured to couple with a wireline telephone. A controller is configured to activate the audible ring tone based on the ring tone data and the incoming caller identification.

According to further embodiments of the present invention, methods for providing customized ring tones for a wireline telephone in a public switched telephone network (PSTN) include receiving ring tone data comprising instructions for providing an audible ring tone based on caller identification. An incoming caller identification from the PSTN network for an incoming call to a wireline telephone is received. A ringer is activated that provides the audible ring tone based on the ring tone data and the incoming caller identification.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIGS. 1-3 are schematic diagrams of systems according to embodiments of the invention; and

FIG. 4 is a block diagram of methods according to embodiments of the invention.

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described below with reference to block diagrams and/or flowchart illustrations of methods, apparatus (systems) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

As will be appreciated by one of skill in the art, the present invention may be embodied as a method, data processing system and/or computer program product. Thus, the present invention may take the form of an entirely hardware embodiment, an entirely software embodiment or an embodiment combining software and hardware aspects, which may be collectively referred to herein as a “circuit” or “module.”

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

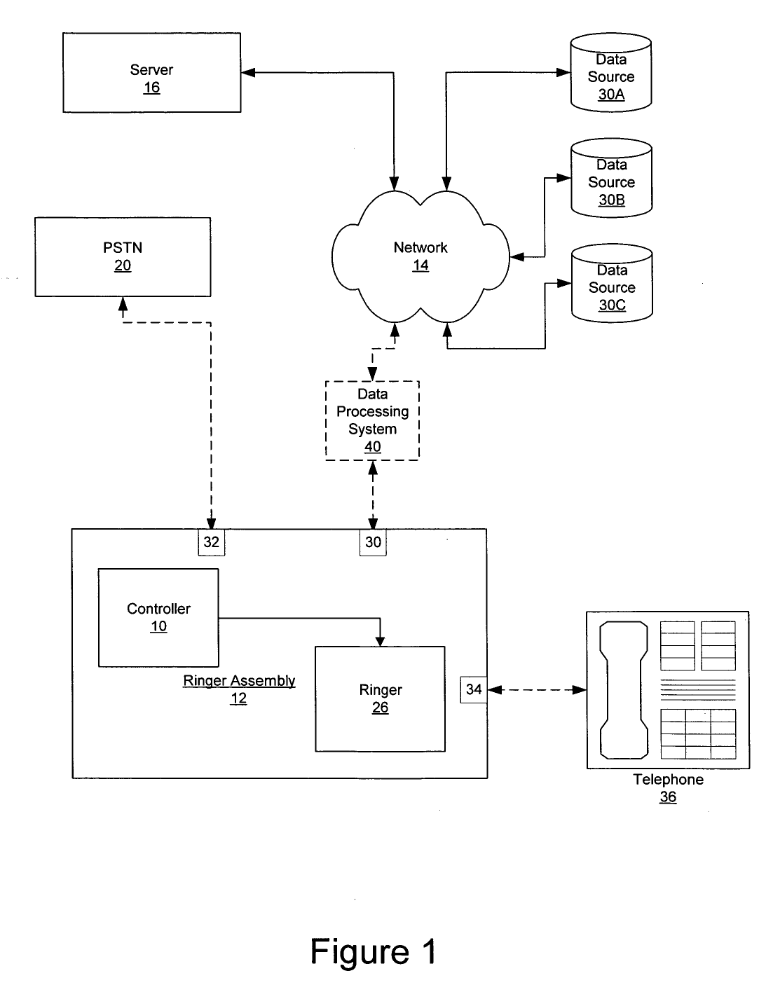

Various embodiments of the present invention will now be described with reference to FIGS. 1 through 4. FIG. 1 illustrates a network environment in which embodiments of the present invention may be utilized. As will be appreciated by those of skill in the art, however, the operations of embodiments of the present invention may be carried out on a single processing system and public telecommunications switching network with or without access to a network such as an intranet or the Internet. As seen in FIG. 1, a ringer assembly 12 can communicate with a network 14, a public telecommunications switching network (PTSN) 20 and/or a telephone 36. The ringer assembly 12 includes a controller 10, a ringer 26, a download interface 30, a PSTN interface 32 and a telephone interface 34. The ringer assembly 12 can be connected directly to the network 14 via the download interface 30 or the ringer assembly 12 can be connected to the network 14 via an optional data processing system 40. The network 14 can provide communications with the ringer assembly 12 and a server 16 and data sources 30A-30C.

As illustrated in FIG. 1, the telephone 36 is a wireline telephone that connects to the PSTN 20 via the ringer assembly 12. As illustrated in FIG. 1, the ringer assembly 12 is connected to the PSTN 20 with the PSTN interface 32, which can be a standard wireline telephone wall jack connector, such as an RJ-11 jack. The ringer 26 of the ringer assembly 12 is configured to provide an audible ring tone based on instructions from the controller 10. In particular, the ringer 26 may be activated by the controller 10 when an incoming call is received from the PSTN network 20 by the PSTN interface 32. The ringer 26 can be an electromechanical sounder that converts an electrical signal to sound waves, such as a piezoelectric sounder, speaker, or other suitable tone generator known to those of skill in the art.

In some embodiments, the ring tones may be customized based on instructions downloaded to the controller 10. A “ring tone” is an audible sound that may be used to indicate that a call is being received. A ring tone may include a plurality of individual tones of different pitches, including a voice or other sound. Accordingly, ring tones that may be more complex (e.g., a melody or other collection of pitches) than a conventional telephone ring may be provided to a landline telephone.

As shown in FIG. 1, the download interface 30 of the ringer assembly 12 is configured to receive information, for example, from the data sources 30A-30C. The data sources 30A-30C can include ring tone data (e.g., including ring tone instructions that may be executed by the controller 10). In some embodiments, the download interface 30 includes a modem interface configured to connect with a modem on a computer; however, other suitable interfaces may be used. For example, although the download interface 30 of the ringer assembly 12 is illustrated as being connectable to the network 14 in FIG. 1, it should be understood that the ring tone data may be downloaded from other sources. For example, a memory device, such as a diskette inserted into a disk drive or a USB memory device connected to a USB port, can be used to download ring tone data.

In particular embodiments, the ringer assembly 12 is connected to the network 14, and ring tone data is downloaded via the download interface 30 from the data sources 30A-30C. The ring tone data may be customized by a user, for example, by selecting specific ring tones from the data sources 30A-30C and assigning a ring tone to specific callers. Moreover, a service provider can collect fees from the user for ring tone services based on the customized ring tone data requested by the user. For example, the user may assign a ring tone downloaded from the data sources 30A-30C to a particular caller using an application on the data processing system 40 or an application available through the server 16. The instructions may be downloaded via the download interface 30 of the ringer assembly 12 and used to program the controller 10. In some embodiments, the caller can assign itself a ring tone downloaded from the data sources 30A-30C. The assigned ring tone can be included in the caller identification information and communicated to the controller 10 so that the assigned ring tone is played when the particular caller calls the ringer assembly 12.

The ringer assembly 12 may be disconnected from the network 14 and connected to the PSTN 20 and the telephone 36 via the PSTN interface 32 and the telephone interface 34. When a call is received from the PSTN 20 by the ringer assembly 12, the controller 10 can select a ring tone assigned to the particular caller. The ring tone instructions may be executed by the ringer 26. A user can identify a particular ring with a certain caller so that the user knows the identity of the caller based on the ring tone played by the ringer assembly 12. The ring tone can be based on the ring tone data received from the data sources 30A-30B. Accordingly, customized ring tones can be provided to a wireline telephone 34 in a PSTN 20 network.

In some embodiments, a conventional ringer in the wireline telephone 36 may be disabled. For example, the controller 10 can be configured to disable the conventional ringer in the landline telephone 36 via the telephone interface 34. In particular, a voltage typically used to enable a conventional ring can be disconnected by the controller 10. In other embodiments, the conventional ringer in the landline telephone 36 may be disabled manually by a user. Thus, the ringer 26 may provide a ring tone when a call is received from the PSTN 20 and the conventional ringer in the landline telephone 36 is silent.

Although the ringer assembly 12, the data processing system 40, and the landline telephone 36 are illustrated in FIG. 1 as separate devices, it should be understood that one or more functions of these components may be combined in one or more device. For example, the data processing system 40 and the ringer assembly 12 may be provided in a single device. In some embodiments, the ringer assembly 12 is provided as a detachable module to the landline telephone 36, and the customized ring tones may be provided to an existing landline telephone. However, the ringer assembly 12 and data processing system 40 may be integrated as part of the landline telephone 36.

The network 14 can be an intranet or the Internet or other networks known to those of skill in the art. The data processing system 40 can be any suitable processing device, such as a personal computer (desktop or laptop), a personal data assistant (PDA), smartphone, or other suitable user terminal. The data processing system 40 and/or ringer assembly 14 can be connected to the network 14 via wireless or wired connections as would be understood by those of skill in the art. The data sources 30A-30C can be computer servers, processing systems, or other networks that can send data to the ringer assembly 12 over the network 14.

In some embodiments, the data processing system 40 receives ring tone data from the data sources 30A-30C via the network 14, for example, from an application that is executed by an Internet browser on a website. The data processing system 40 can download the ring tone data to the download interface 30 of the ringer assembly while the system 40 is connected to the network 14 or after the system 40 is disconnected from the network 14.

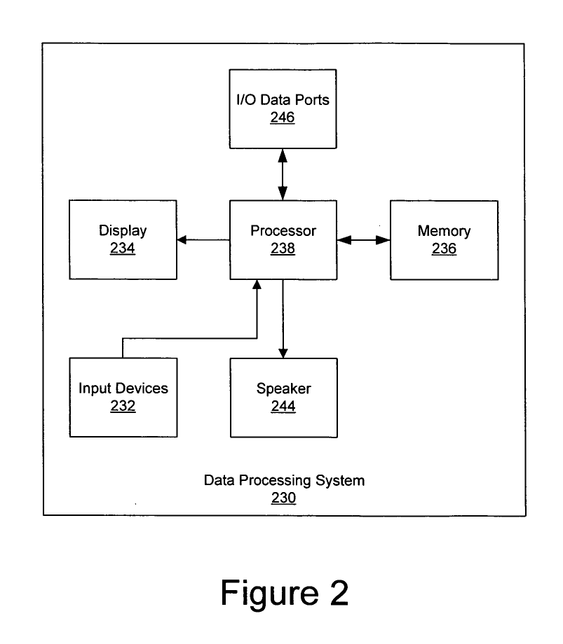

Referring to FIG. 2, a data processing system 230 is shown. As will be appreciated by those of skill in the art, the data processing system 230 may be configured as the ringer assembly 12, the data processing system 40 or the server 16 of FIG. 1. The data processing system 230 typically includes input device(s) 232 such as a keyboard or keypad, touch sensitive screen, light sensitive screen, or mouse, a display 234, and a memory 236 that communicates with a processor 238. The data processing system 230 may further include a speaker 244, and an I/O data port(s) 246 that also communicates with the processor 238. The I/O data port 246 can be used to transfer information between the data processing system 230 and another computer system or a network (e.g., the network 14 and/or the ringer assembly 12 of FIG. 1). These components may be conventional components such as those used in many conventional data processing systems, which may be configured to operate as described herein.

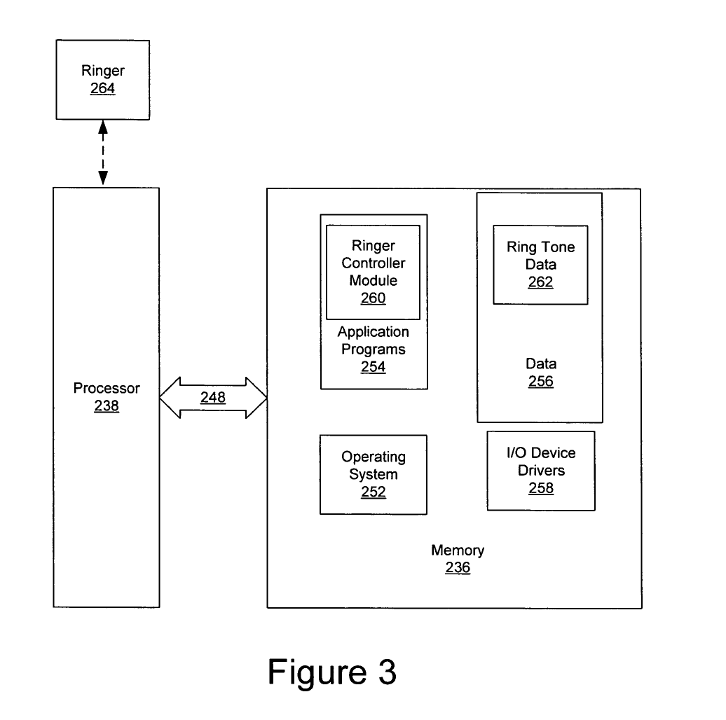

FIG. 3 is a block diagram of embodiments of data processing systems that illustrates systems, methods, and computer program products in accordance with the present invention. The processor 238 may be configured to execute certain functionalities as described herein with respect to the controller 10 of the ringer assembly 12, the data processing system 40 or the server 16 of FIG. 1. The processor 238 communicates with the memory 236 via an address/data bus 248. The processor 238 can be any commercially available or custom microprocessor. The memory 236 is representative of the overall hierarchy of memory devices containing the software and data used to implement the functionality of the data processing system 230. The memory 236 can include, but is not limited to, the following types of devices: cache, ROM, PROM, EPROM, EEPROM, flash memory, SRAM, and DRAM.

As shown in FIG. 3, the memory 236 may include several categories of software and data used in the data processing system 230: an operating system 252; application programs 254; input/output (I/O) device drivers 258; and data 256. As will be appreciated by those of skill in the art, the operating system 252 may be any operating system suitable for use with a data processing system, such as OS/2, AIX or System390 from International Business Machines Corporation, Armonk, N.Y., Windows95, Windows98, Windows2000, or WindowsXP from Microsoft Corporation, Redmond, Wash., Unix or Linux. The I/O device drivers 258 typically include software routines accessed through the operating system 252 by the application program 254 to communicate with devices such as the input devices 232, the display 234, the speaker 244, the I/O data port(s) 246, and certain components of the memory 236. The application programs 254 are illustrative of the programs that implement the various features of the data processing system 230 and can include at least one application which provides operations of embodiments of the present invention. The data 256 represents the static and dynamic data used by the application programs 254, the operating system 252, the I/O device drivers 258, and other software programs that may reside in the memory 236.

As is further seen in FIG. 3, the application programs 254 can include a ringer controller 260, the data 256 can include ring tone data 262, and a ringer 264 can be in communication with the processor 238. The ringer controller 260 may carry out operations as described herein for instructing the ringer 264 to execute a ring tone based on the ring tone data 262. For example, the ring tone data 262 can include a plurality of discrete ring tones, i.e., instructions for a pattern of one or more tones that may be executed by the ringer 264. The ringer controller 260 can be configured as the controller 10 and the ringer 264 can be configured as the ringer 26 in FIG. 1.

In particular embodiments, the ring tone data 262 can further include instructions for selecting one of a plurality of ring tones based on the caller identification of an incoming call from the PSTN 20 of FIG. 1. The ring tone selection may be programmed by a user. For example, a caller and/or incoming telephone number can be identified using caller identification techniques known to those of skill in the art, and a ring tone may be selected based on the identified caller and/or telephone number.

The present invention should not be construed as limited to the configurations of FIGS. 1-3 but is intended to encompass any configuration capable of carrying out the operations described herein. For example, although embodiments of the present invention is illustrated, for example, with reference to the ringer controller 260, ring tone data 262, and ringer 264, as will be appreciated by those of skill in the art, the ringer controller 260, ring tone data 262, and ringer 264 may also be incorporated into other components, such as the operating system 252.

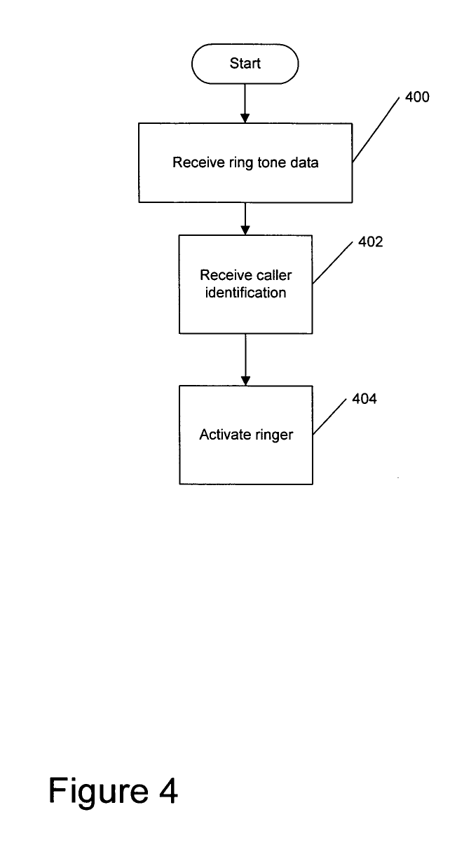

Embodiments of the present invention will now be described with reference to FIG. 4, which is a flowchart illustration of operations. As illustrated in FIG. 4, ring tone data, including instructions for providing an audible ring tone based on caller identification, is received at Block 400. Caller identification from the PSTN network for an incoming call to the wireline telephone is received at Block 402. The ringer that provides the audible ring tone is activated based on the ring tone data and the incoming caller identification at Block 404.

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A ringer assembly for providing customized ring tones for a wireline telephone in a public switched telephone network (PSTN), the ringer assembly being in communication with a ringer configured to provide an audible ring tone, the ringer assembly comprising:
a download interface configured to receive ring tone data comprising instructions for providing an audible ring tone based on a caller identification;
a PSTN interface configured to couple with a PSTN network and to receive incoming caller identification from the PSTN network;
a telephone interface configured to couple with a wireline telephone; and
a controller configured to activate the audible ring tone based on the ring tone data and the incoming caller identification.

2. The ringer assembly of claim 1, wherein the download interface is configured to couple with a computer network and to receive ring tone data therefrom.

3. The ringer assembly of claim 2, wherein the incoming caller identification includes a caller phone number and the ring tone data includes programmable instructions for selecting one of a plurality of ring tones based on the caller phone number.

4. The ringer assembly of claim 2, wherein the computer network comprises the Internet.

5. The ringer assembly of claim 1, wherein the ringer is a first ringer and the wireline telephone includes a second ringer, wherein the controller is further configured to disable the second ringer.

6. The ringer assembly of claim 1, wherein the audible ring tone comprises a plurality of individual tones of different pitches.

7. The ringer assembly of claim 1, further comprising a ringer configured to provide an audible ring tone.

8. The ringer assembly of claim 1, wherein the PSTN network includes a caller identification service and the PSTN interface is configured to download incoming caller identification from caller identification service.

9. A method for providing customized ring tones for a wireline telephone in a public switched telephone network (PSTN), the method comprising:
receiving ring tone data comprising instructions for providing an audible ring tone based on caller identification;
receiving an incoming caller identification from the PSTN network for an incoming call to a wireline telephone;
activating a ringer to provide the audible ring tone based on the ring tone data and the incoming caller identification.

10. The method of claim 9, wherein the ring tone data is received from a computer network.

11. The method of claim 9, wherein the incoming caller identification includes a caller phone number and the ring tone data includes programmable instructions for selecting one of a plurality of ring tones based on the caller phone number.

12. The method of claim 10, wherein the computer network comprises the Internet.

13. The method of claim 9, wherein the ringer is a first ringer and the wireline telephone includes a second ringer, the method further comprising disabling the second ringer.

14. The method of claim 9, wherein the audible ring tone comprises a plurality of individual tones of different pitches.

15. A computer program product for providing customized ring tones for a wireline telephone in a public switched telephone network (PSTN) comprising a computer readable medium having computer readable program code embodied therein, the computer readable program product comprising:
computer readable program code configured to receive to ring tone data comprising instructions for providing an audible ring tone based on caller identification;
computer readable program code configured to receive an incoming caller identification from the PSTN network for an incoming call to a wireline telephone;
computer readable program code configured to activate a ringer that provides the audible ring tone based on the ring tone data and the incoming caller identification.

16. The computer program product of claim 15, wherein the ring tone data is received from a computer network.

17. The computer program product of claim 16, wherein the incoming caller identification includes a caller phone number and the ring tone data includes computer readable program code configured to select one of a plurality of ring tones based on the caller phone number.

18. The computer program product of claim 16, wherein the computer network comprises the Internet.

19. The computer program product of claim 15, wherein the ringer is a first ringer and the wireline telephone includes a second ringer, the computer program product further comprising computer readable program code configured to disable the second ringer.

20. The computer program product of claim 15, wherein the audible ring tone comprises computer readable program code configured to execute a plurality of individual tones of different pitches.
